(19) United States
(12) Patent Application Publication
(10) Pub. No.: US 2015/0231972 A1
(43) Pub. Date: Aug. 20, 2015

(54) CONTROL APPARATUS FOR VEHICLE

(71) Applicant: TOYOTA JIDOSHA KABUSHIKI KAISHA, Toyota-shi Aichi-ken (JP)

(72) Inventors: Shohei Oi, Toyota-shi Aichi-ken (JP); Ryoji Sato, Toyohashi-shi Aichi-ken (JP); Tomoko Oba, Nagoya-shi Aichi-ken (JP)

(21) Appl. No.: 14/607,610

(22) Filed: Jan. 28, 2015

(30) Foreign Application Priority Data
Feb. 20, 2014 (JP) 2014-031124

(51) Int. Cl. B60L 3/04; H02H 1/06

(52) U.S. Cl. CPC B60L 3/04; H02H 1/06

(57) ABSTRACT

A control unit, on the occasion of a collision of a vehicle, causes a boost converter and an inverter to supply electric power to a motor generator such that the motor generator outputs no toque to make the motor generator perform discharge of a smoothing capacitors. When the discharge by the motor generator cannot be performed, the control unit causes the boost converter to transfer electric charges to a side of the boost converter to which a discharge circuit is connected to thereby make the discharge circuit perform discharge.

### PRIORITY INFORMATION

This application claims priority to Japanese Patent Application No. 2014-031124, filed on Feb. 20, 2014, which is incorporated herein by reference in its entirety.

### TECHNICAL FIELD

The present invention relates to a control apparatus for a vehicle, which is mounted on a vehicle to control discharge of a capacitor upon a collision of the vehicle.

### BACKGROUND

Hybrid vehicles (HVs) and electric vehicles (EVs) normally include a smoothing capacitor so as to stabilize the direct-current voltage in a driving circuit of a motor generator. In the HVs and EVs designed to supply the battery voltage increased by a DC/DC converter to an inverter and drive the motor generator by power from the inverter, for example, a large smoothing capacitor is provided on the input side of the inverter (i.e., the output side of the DC/DC converter) in order to stabilize the input voltage to the inverter.

Discharge (charge extraction) of this smoothing capacitor is required on the occasion of a collision of a vehicle.

JP 2010-178595 A discloses controlling power supply to a motor generator such that the motor generator outputs zero torque on the occasion of a collision of a vehicle, thereby performing charge extraction of a smoothing capacitor. Specifically, in the vector control of the motor generator, zero torque control is executed by supplying only d-axis current to the motor generator, such that the motor generator generates zero output torque while consuming power of the smoothing capacitor, thereby executing charge extraction of the smoothing capacitor.

### SUMMARY

### Technical Problem

When a resolver (i.e., a rotation detection sensor which detects a rotation position of a rotor), a current sensor which detects electric current of each phase of the motor generator, and the like, that are mounted on the motor generator, fail because of an impact of a collision of the vehicle, it is not possible to perform charge extraction of the smoothing capacitor by the motor generator in an appropriate manner.

### Solution to Problem

In accordance with an aspect of the present invention, a control apparatus for a vehicle includes a battery, a DC/DC converter connected to the battery for performing voltage conversion, an inverter connected to the DC/DC converter for performing direct current to alternating current conversion, a motor generator connected to the inverter for outputting a driving force, smoothing capacitors provided on an input side and an output side of the DC/DC converter, respectively, a discharge circuit connected to the input side or the output side of the DC/DC converter, and a control unit. The control unit causes, on the occasion of a collision of the vehicle, the DC/DC converter and the inverter to supply electric power to the motor generator to make the motor generator perform discharge of the smoothing capacitors, and causes, when the discharge by the motor generator cannot be performed, the DC/DC converter to transfer electric charges to a side of the DC/DC converter to which the discharge circuit is connected to thereby make the discharge circuit perform discharge of the smoothing capacitors.

According to one embodiment, “when the discharge by the motor generator cannot be performed” refers to when a current sensor of the motor generator fails, when a rotation detection sensor of the motor generator fails, or when the motor generator fails.

According to another embodiment, the discharge circuit is provided on the one of the input side and the output side of the DC/DC converter on which an insulation property is higher.

In accordance with another aspect of the invention, a control apparatus for a vehicle includes a battery, a DC/DC converter connected to the battery for performing voltage conversion, an inverter connected to the DC/DC converter for performing direct current to alternating current conversion, a motor generator connected to the inverter for outputting driving force, smoothing capacitors provided on an input side and an output side of the DC/DC converter, respectively, and a control unit. The control unit causes, on the occasion of a collision of the vehicle, the DC/DC converter and the inverter to supply electric power to the motor generator to make the motor generator perform discharge of the smoothing capacitors, and causes, when the discharge by the motor generator cannot be performed, the DC/DC converter to transport electric charges to the one of the input side and the output side of the DC/DC converter on which an insulation property is higher.

### Advantageous Effects

According to the present invention, it is possible to appropriately perform required charge extraction of a capacitor, even when a resolver (i.e., a rotation detection sensor which detects a rotation position of a rotor), a current sensor which detects electric current of each phase of the motor generator, and the like, that are mounted on the motor generator, fail because of an impact of a collision of the vehicle.

### BRIEF DESCRIPTION OF THE DRAWINGS

Preferred embodiments of the present invention will be described in detail by reference to the following figures, wherein:

FIG. 1 is a block diagram schematically illustrating a driving system of a hybrid vehicle including a control apparatus for a vehicle according to an embodiment of the present invention;

FIG. 2 is a view illustrating an internal structure or the like of a boost converter according to one embodiment of the present invention;

FIG. 3 is a flow chart illustrating processing performed on the occasion of a vehicle collision in the embodiment illustrated in FIG. 1;

FIG. 4 is a view a view illustrating an internal structure or the like of a boost converter according to another embodiment of the present invention; and

FIG. 5 is a flow chart illustrating processing performed on the occasion of a vehicle collision in the embodiment illustrated in FIG. 4.

### DESCRIPTION OF EMBODIMENTS

Preferred embodiments of the present invention will be described in detail with reference to the accompanying drawings. It should be noted that the present invention is not limited to the embodiments described below.

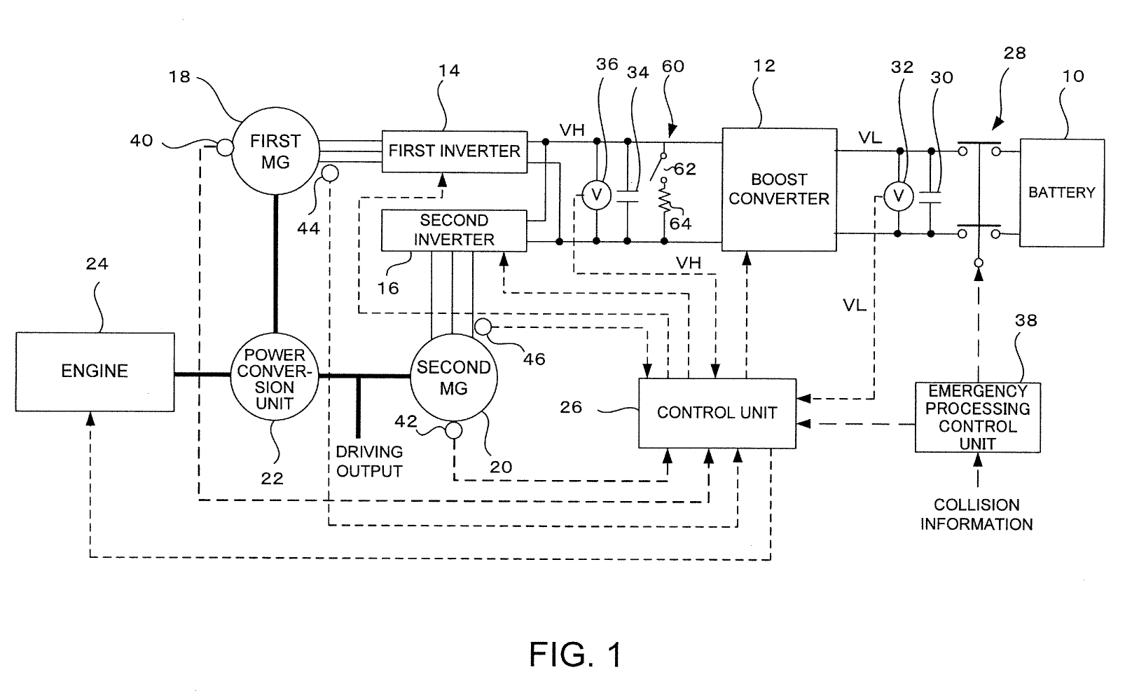

FIG. 1 is a block diagram schematically illustrating a driving system of a hybrid vehicle including a control apparatus for a vehicle according to an embodiment of the present invention.

Direct-current output VL of a battery 10 is supplied, via a main relay 28, to a boost converter 12. The boost converter 12 is a DC/DC converter which performs voltage boost and voltage decrease, and generally boosts unboosted voltage VL output from the battery 10 to boosted voltage VH and supplies the boosted voltage VH to a first inverter 14 and a second inverter 16. A first MG (motor generator) 18 for power generation is connected to the first inverter 14, and a second MG (motor generator) 20 for driving is connected to the second inverter 16.

Output shafts of the first MG 18 and the second MG 20 are connected to a power conversion unit 22, to which an output shaft of an engine 24 is also connected. The rotation of the output shaft connecting the power conversion unit 22 and the second MG 20 is transmitted, as a driving output, to a drive shaft of the vehicle; i.e., the output of the power conversion unit 22 and/or the second MG 20 is transmitted to wheels to allow the hybrid vehicle to travel.

The power conversion unit 22 is formed, for example, of a planetary gear mechanism, for controlling power transmission among the first and second MGs 18 and 20, the engine 24, and a driving output which drives tires. The engine 24 is basically used as an output source of power, and the output of the engine 24 is transmitted, via the power conversion unit 22, to the first MG 18. The first MG 18 thus generates power by the output of the engine 24, and the generated power is used to charge the battery 10 via the first inverter 14 and the boost converter 12. The output of the engine 24 is also transmitted, via the power conversion unit 22, to the drive shaft, so that the vehicle can travel by the output of the engine 24. In FIG. 1, the transmission system of electric power is indicated by normal solid lines; the transmission system of mechanical power is indicated by bold solid lines; and the transmission system (control system) of signals is indicated by dashed lines.

A control unit 26 controls driving of the first and second inverters 14 and 16, and the engine 24, in accordance with the target torque, and the like, which is determined based on an accelerator stepping amount and the vehicle speed, to control the output to the drive shaft. The control unit 26 also controls driving of the engine 24 and switching of the first inverter 14, in accordance with the state of charge (SOC) of the battery, to thereby control charging of the battery 10. At the time of deceleration of the vehicle, the control unit 26 controls the second inverter 16 to cause the second MG 20 to perform regenerative braking, so that the battery 10 is charged with the regenerated power. Alternatively, the first MG 18 may be used to perform regenerative braking.

Between the positive side and the negative side on the VL side, which is the output of the battery 10, a capacitor 30 for smoothing the output voltage of the battery 10 is provided, and an unboosted-voltage sensor 32 which measures the unboosted voltage VL of the capacitor 30 is also provided. Further, on the output side of the boost converter 12, a capacitor 34 for smoothing the boosted voltage VH is provided, and a boosted-voltage sensor 36 which measures the voltage of this capacitor 34; i.e., the boosted voltage VH, is also provided. The boosted voltage VH is input to the first and second inverters 14 and 16. Also, the first and second MGs 18 and 20 include rotation detection sensors (resolvers) 40 and 42 for detecting the rotation phase (rotor position) thereof, and current sensors 44 and 46 for detecting current of each phase, respectively, provided thereon.

The control unit 26 controls the first and second inverters 14 and 16, and controls driving of the first and second MGs 18 and 20, as described above, based on the detection signals from the rotation detection sensors 40 and 42 and the current sensors 44 and 46. The control unit 26, for example, calculates target d-axis and q-axis currents in accordance with the target torque, and determines the power supplied to the first and second MGs 18 and 20 in accordance with the actual d-axis and q-axis currents obtained from the current of each phase and the rotation phase.

According to the present embodiment, an emergency processing control unit 38 is further provided to control the main relay 28 in accordance with collision information and also to supply control information to the control unit 26 on the occasion of a collision.

According to the present embodiment, on the VH side, a discharge circuit 60 formed of a series circuit including a discharge switch 62 and a discharge resistor 64 is provided.

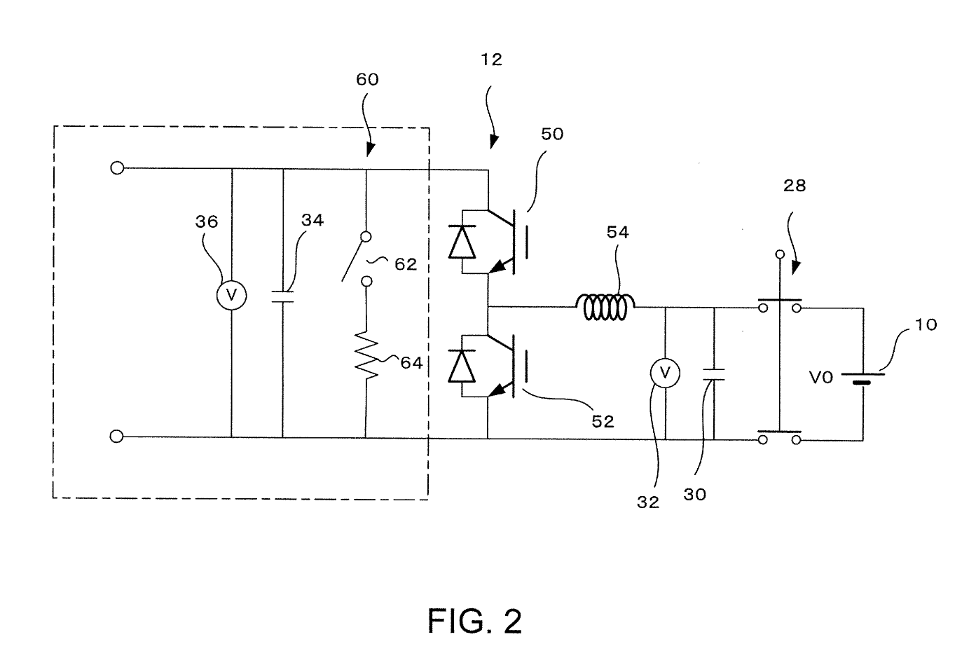

FIG. 2 illustrates an internal structure of the boost converter 12. The boost converter 12 is formed of two switching elements 50 and 52, which are connected in series with each other, and a single reactor 54 connected to a midpoint of the switching elements 50 and 52. Each of the switching elements 50 and 52 is composed of a transistor, such as an IGBT, and a diode for applying current in the reverse direction of the transistor.

One end of the reactor 54 is connected to the positive electrode of the battery 10 (positive side of VL), and the other end of the reactor 54 is connected to the midpoint between the switching elements 50 and 52. The switching element 50 includes a transistor having a collector connected to the positive electrode bus bars (the positive side of VH) of the first and second inverters 14 and 16, and an emitter connected to the collector of the transistor of the switching element 52. The transistor of the switching element 52 has an emitter connected to the negative electrode of the battery 10 and the negative electrode bus bars of the first and second inverters 14 and 16 (the negative side of VH and VL).

The unboosted voltage VL and the boosted voltage VH detected by the unboosted-voltage sensor 32 and the boosted-voltage sensor 36, respectively, are supplied to the control unit 26. The control unit 26, based on the target output torque or the like, determines the target boosted voltage VH, and controls the boost converter 12 such that the boosted voltage VH corresponds to the target value.

As described above, according to the present embodiment, the discharge circuit 60 is provided on the VH side. The discharge circuit 60 is formed of a series circuit including the discharge switch 62 and the discharge resistor 64, and is provided between the positive side and the negative side of the boosted voltage VH such that the discharge circuit 60 is connected in parallel with the capacitor 34.

In FIG. 2, concerning the portion enclosed by a dashed and single-dotted line, a portion on the boosted voltage VH side is formed in a mechanically robust manner or is covered with an insulation material so as to establish insulation; i.e., a high insulation property, even on the occasion of a collision.

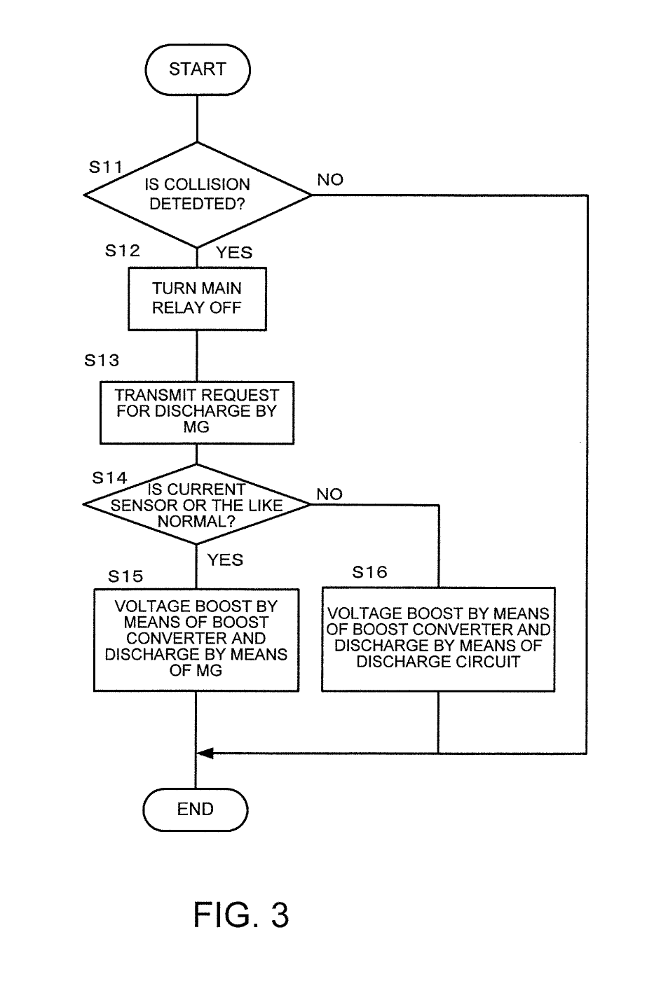

Processing upon the collision in such a vehicle configured as described above will be described by reference to FIG. 3. In this example, while the emergency processing control unit 38 is employed to detect a collision and execute the processing on the occasion of a collision whereas the control unit 26 controls the boost converter 12 and the first and second inverters 14 and 16, the control unit 26 may perform the emergency processing.

First, the emergency processing control unit 38 determines whether or not a collision is detected (S11). This determination may be made based on the detection as to whether or not the acceleration obtained by an acceleration sensor or the like is equal to or higher than a predetermined value, or may be made based on the operation signal of an air bag. If NO is determined by the determination in step S11, it is determined that no collision has occurred and the processing is terminated.

If YES is determined in step S11, on the other hand, the emergency processing control unit 38 turns the main relay 28 off (S12), which disconnects the battery 10 from the boost converter 12 and the driving circuits of the first and second MGs 18 and 20 in the subsequent stages. At this time, turning off of the main relay 28 does not affect the operation of the control unit 26 or the like, as power is supplied to the control unit 26 or the like by an auxiliary battery. Also, it is desirable to continue power supply from the battery 10 to the DC/DC converter for supplying power to the auxiliary battery.

Even when the main relay 28 is turned off to disconnect the battery 10 as described above, electric charges remain in the capacitors 30 and 34, and these charges should be discharged. The emergency processing control unit 38 therefore transmits to the control unit 26 a command for consumption of the power by the first MG 18 or the second MG 20 (request for discharge by MG) (S13).

The control unit 26, when receiving the request for discharge by MG, first determines whether or not the current sensors 44 and 46 and the rotation detection sensors 40 and 42 are normal (S14). Specifically, the control unit 26 determines whether or not at least one of a set of the current sensor 44 and the rotation detection sensor 40 and a set of the current sensor 46 and the rotation detection sensor 42 operates normally. These sensors are determined not to be normal when they fail due to breakage, for example. Alternatively, failure of the first or second MG 18, 20 itself may be determined.

IF YES is determined in the determination in step S14, zero torque control is performed by using either one of the first and second MGs 18 and 20. More specifically, for vector control of the first or second MG 18, 20, only d-axis current is supplied to the first or second MG 18, 20 such that the MG generates zero output torque while consuming power, thereby executing charge extraction of the capacitors 30 and 34 (S15).

According to the present embodiment, in order to consume the electric charges accumulated in the capacitor 30 as well as the electric charges accumulated in the capacitor 34, the boost converter 12 is driven to transport the charges from the unboosted voltage VL side to the boosted voltage VH side. This allows not only the charges accumulated in the capacitor 34 but also the charges accumulated in the capacitor 30 to be consumed by the first or second MG 18, 20.

In order to achieve the zero torque control, power supply is performed with respect to the first or second MG 18, 20 such that the first or second MG 18, 20 generates no output torque, and it is necessary to supply only the d-axis current to the first or second MG 18, 20, as described above. If the current sensor 44 and the rotation detection sensor 40 associated with the first MG 18, or the current sensor 46 and the rotation detection sensor 42 associated with the second MG 20 fail, it is not possible to execute such control, and a possibility of generation of the output torque would arise. Therefore, when the current sensor 44 and the rotation detection sensor 40 associated with the first MG 18, or the current sensor 46 and the rotation detection sensor 42 associated with the second MG 20 fail, the first or second MG 18, 20 which fails would not be employed, and the zero torque control is performed by using the first or second MG 18, 20 which can provide a normal current and normal rotation phase. It should be noted that, while for the zero torque control, it is preferable to make the output torque zero, an output torque may be generated, so long as generation of the torque does not cause any problems.

If NO is determined in the determination in step S14; that is, if neither the first nor second MG 18, 20 includes the normal current sensor 44, 46 nor the normal rotation detection sensor 40, 42, discharge by means of voltage boost is performed (S16). Specifically, the boost converter 12 is used to transfer the charges on the VL side to the VH side, and also the discharge switch 62 in FIG. 2 is turned on to allow the charges on the VH side to be discharged by the discharge resistor 64. This allows the electric charges accumulated in both the two capacitors 30 and 34 to be consumed.

According to the present embodiment, as the boost converter 12 is used to transport the electric charges on the occasion of a collision, it is possible to release the electric charges accumulated in the capacitors 30 and 34 provided on both the upstream side (VL side) of the boost converter and the downstream side (VH side) of the boost converter, as described above.

Further, when discharge with the use of the first or second MG 18, 20 can be performed, effective discharge can be executed by using such a motor generator, whereas, when discharge with the use of the first or second MG 18, 20 cannot be performed, discharge can be performed by using the discharge circuit 60.

### Another Embodiment

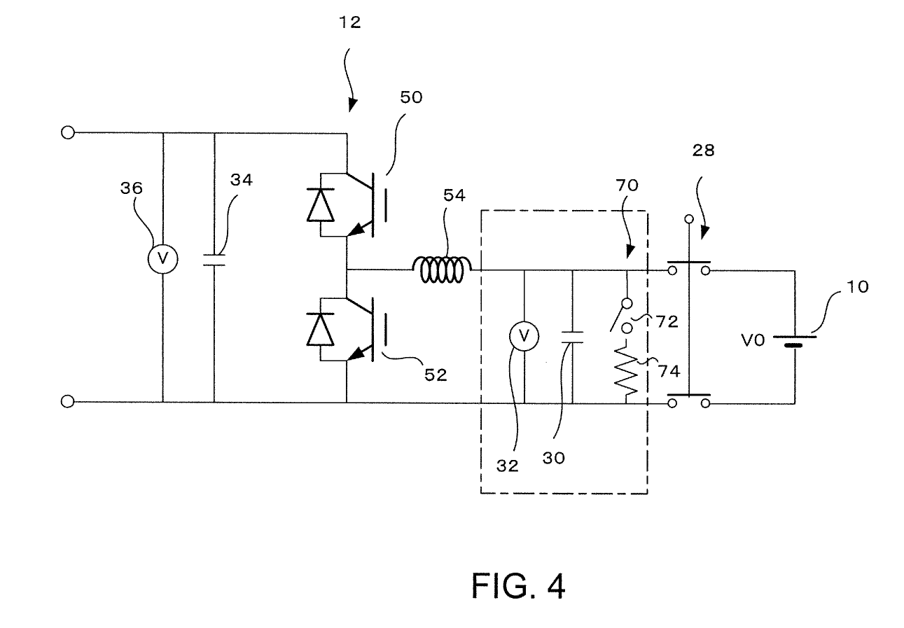

FIG. 4 illustrates a structure of a control apparatus according to another embodiment. In this example, a discharge circuit 70 formed of a discharge switch 72 and a discharge resistor 74 which are connected in series with each other is provided on the VL side; i.e., in parallel to the capacitor 30 on the upstream side of the boost converter 12. More specifically, in this example, insulation on the VL side of the boost converter 12 is ensured to achieve a high insulation property.

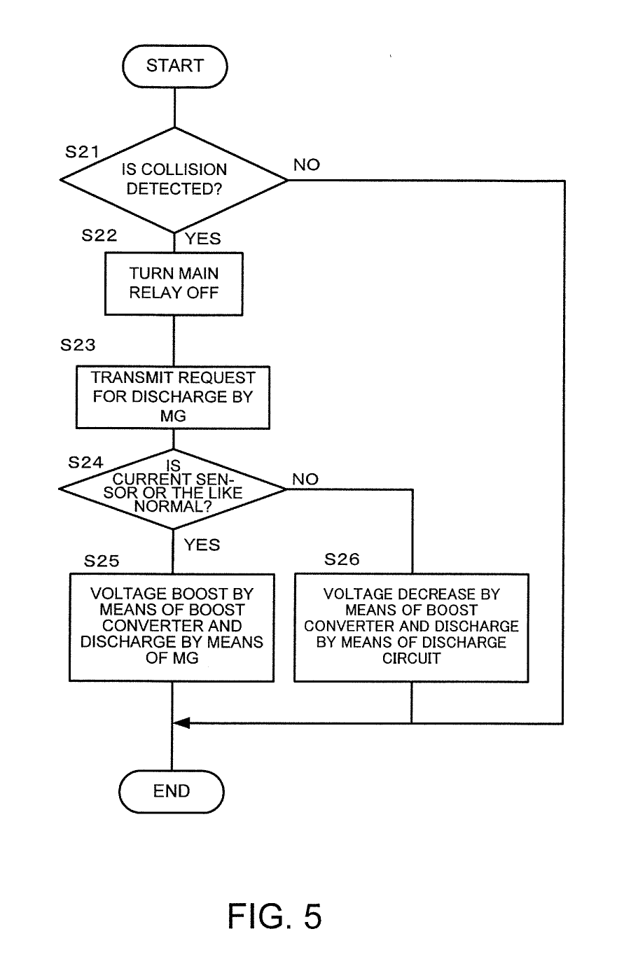

FIG. 5 shows a flow chart of processing in this embodiment, in which, “discharge by means of voltage decrease” is adopted in step S26, in place of “discharge by means of voltage boost” in step S16 of FIG. 3, and steps S21 to S25 correspond to S11 to S15 in FIG. 3, respectively.

Specifically, in this embodiment, if NO is determined in step S24 and it is determined that neither the first nor second MG 18, 20 includes the normal current sensor 44, 46 nor the normal rotation detection sensor 40, 42, discharge by means of voltage decrease is performed (S26). More specifically, the electric charges on the VH side are transferred by the boost converter 12 to the VL side, and the discharge switch 72 in FIG. 4 is turned on to allow the electric charges on the VL side to be discharged by the discharge resistor 74. As such, it is possible to consume the electric charges accumulated in both of the two capacitors 30 and 34.

As described above, according to the two embodiments described above, on the occasion of a collision, the boost converter 12 is employed to transport the electric charges to a side on which the discharge circuit 60, 70 is provided. It is therefore possible to discharge the electric charges accumulated in the capacitors 30 and 34 both on the upstream side (VL side) and on the downstream side (VH side) of the boost converter 12.

According to either of the two embodiments, when discharge by means of the first or second MG 18, 20 can be performed, it is possible to perform effective discharge by using one or both of the first and second MGs 18 and 20, whereas when discharge by means of neither the first nor second MG 18, 20 cannot be performed, discharge by means of the discharge circuit 60, 70 can be performed. In particular, voltage boost or voltage decrease by means of the boost converter 12 enables discharge of the two capacitors 30 and 34. Further, the discharge circuit 60, 70 is placed in a portion of the vehicle where insulation can be secured, so that safe discharge processing can be executed.

### Further Embodiment

In still another embodiment, in a case in which the discharge circuit 60, 70 is not provided or the discharge circuit 60, 70 does not function, when insulation is ensured on one of the upstream side (VL side) or the downstream side (VH side) of the boost converter 12, electric charges are transported to the side where insulation is ensured. More specifically, when insulation is ensured on either the upstream side (VL side) or the downstream side (VH side) of the boost converter 12, as described above, transportation of the electric charges to the safer side can ensure safety of the vehicle, and establishment of insulation on one side of the boost converter 12 can provide an advantage which is similar to that obtained when insulation is ensured on both sides of the boost converter 12.

In this case, in step S16 or S26 in FIG. 3 or FIG. 5, discharge by the discharge circuit 60, 70 is not performed and only transportation of electric charges by the boost converter 12 is performed.

### REFERENCE SYMBOLS LIST

10 battery, 12 boost converter, 14, 16 inverter, 18, 20 first, second MG (motor generator), 22 power conversion unit, 24 engine, 26 control unit, 28 main relay, 30, 34 capacitor, 32 unboosted-voltage sensor, 36 boosted-voltage sensor, 38 emergency processing control unit, 40, 42 rotation detection sensor, 44, 46 current sensor, 50, 52 switching element, 54 reactor, 60, 70 discharge circuit, 62, 72 discharge switch, 64, 74 discharge resistor.

1. A control apparatus for a vehicle comprising:
a battery;
a DC/DC converter connected to the battery, the DC/DC converter performing voltage conversion;
an inverter connected to the DC/DC converter, the inverter performing direct current to alternating current conversion;
a motor generator connected to the inverter, the motor generator outputting a driving force;
smoothing capacitors provided on an input side and an output side of the DC/DC converter, respectively;
a discharge circuit connected to the input side or the output side of the DC/DC converter; and
a control unit configured to cause, on the occasion of a collision of the vehicle, the DC/DC converter and the inverter to supply electric power to the motor generator to make the motor generator perform discharge of the smoothing capacitors, the control unit being configured to cause, when the discharge by the motor generator cannot be performed, the DC/DC converter to transfer electric charges to a side of the DC/DC converter to which the discharge circuit is connected to thereby make the discharge circuit perform discharge of the smoothing capacitors.

2. The control apparatus for a vehicle according to claim 1, wherein
when the discharge by the motor generator cannot be performed refers to any of when a current sensor of the motor generator fails, when a rotation detection sensor of the motor generator fails, and when the motor generator fails.

3. The control apparatus for a vehicle according to claim 1, wherein
the discharge circuit is provided on the one of the input side and the output side of the DC/DC converter on which an insulation property is higher.

4. The control apparatus for a vehicle according to claim 2, wherein
the discharge circuit is provided on the one of the input side and the output side of the DC/DC converter on which an insulation property is higher.

5. A control apparatus for a vehicle comprising:
a battery;
a DC/DC converter connected to the battery, the DC/DC converter performing voltage conversion;
an inverter connected to the DC/DC converter, the inverter performing direct current to alternating current conversion;
a motor generator connected to the inverter, the motor generator outputting driving force;
smoothing capacitors provided on an input side and an output side of the DC/DC converter, respectively; and
a control unit configured to cause, on the occasion of a collision of the vehicle, the DC/DC converter and the inverter to supply electric power to the motor generator to make the motor generator perform discharge of the smoothing capacitors, the control unit being configured to cause, when the discharge by the motor generator cannot be performed, the DC/DC converter to transport electric charges to the one of the input side and the output side of the DC/DC converter on which an insulation property is higher.

6. The control apparatus for a vehicle according to claim 5, wherein
when the discharge by the motor generator cannot be performed refers to any of when a current sensor of the motor generator fails, when a rotation detection sensor of the motor generator fails, and when the motor generator fails.
